(19) United States
(12) Patent Application Publication
(10) Pub. No.: US 2012/0041573 A1
(43) Pub. Date: Feb. 16, 2012

(54) DYNAMIC GAIN CONTROLLER AND CONTROL METHOD FOR A CONTROL PLANT

(75) Inventors: WEI-HSU CHANG, NEW TAIPEI CITY (TW); YU-KUANG WU, HSINCHU COUNTY (TW)

(73) Assignee: RICHTEK TECHNOLOGY CORP., HSINCHU (TW)

(21) Appl. No.: 13/190,631

(22) Filed: Jul. 26, 2011

(30) Foreign Application Priority Data
Aug. 10, 2010 (TW) 099126656

(51) Int. Cl. G05B 13/02

(52) U.S. Cl. 700/37

(57) ABSTRACT

A dynamic gain controller for providing an adjust value for a control plant to control an output value of the control plant, detects an error value between a feedback value related to the output value and an input reference value, and compares the error value with a threshold to select a gain for amplifying the error value to generate the adjust value. The dynamic gain control will make the control plant to have a shorter settling time and a stable output value.

### FIELD OF THE INVENTION

The present invention is related generally to a linear control system and, more particularly, to a dynamic gain controller and control method for a control plant.

### BACKGROUND OF THE INVENTION

FIG. 1 shows a traditional fixed gain close loop linear feedback control system, in which a unit gain controller 10 provides an adjust value Sc for a control plant 18 to control the output value OV of the control plant 18. In the unit gain controller 10, a feedback circuit 16 detects the output value OV to generate a feedback value FB related to the output value OV, an operational circuit 12 has two input terminals receiving the feedback value FB and an input reference value Ref, respectively, and an output terminal outputting the error value Err between the reference value Ref and the feedback value FB, and an amplifier 14 amplifies the error value Err with a gain A to generate the adjust value Sc. Typically, a general digital control system is set with a proper gain A as the control parameter according to the target it is applied to. However, most of users desire a control system to have its output value reaching a stable set value in a settling time as short as possible when the input or the load is changed. For a general fixed gain close loop linear feedback control system, the reference value Ref sets the output value OV, and the gain A changes the settling time. However, while setting a large gain A helps the output value OV to reach the set value sooner, it may also lead to unstable output. On the other hand, setting a small gain A ensures a stable output, yet this makes the settling time excessively long or even, when the gain is small to an extent, makes the output become stable before the output value OV reaches the set value, which brings about a static error between the output value and the set value.

For example, in a fixed gain single phase digital brushless direct current (BLDC) fan control system, the reference value Ref is the set reference revolutions per minute (RPM), the feedback value FB is the fed back output RPM, the control plant 18 is a BLDC fan, and with the error value Err between the reference RPM Ref and the fed back output RPM FB and through the linear operation of the amplifier 14, the RPM of the BLDC fan 18 is controlled. FIG. 2 is a functional block diagram of a single phase digital BLDC fan control system, in which output terminals OUT1 and OUT2 are connected to a fan motor 34, and by setting the on time and on/off order of four switches M1, M2, M3 and M4 in an H bridge, it can control the level and direction of the currents at the output terminals OUT1 and OUT2, thereby varying the RPM of the fan motor 34. The RPM of the fan motor 34 is fed back by a feedback circuit 23 which includes a Hall component 24 for detecting the RPM of the fan motor 34, and the output of the Hall component 24 is converted into a current RPM FB. A reference RPM assign circuit 19 provides the reference RPM Ref, which includes a duty-to-RPM converter 20 and a lookup table 22. The duty-to-RPM converter 20 decodes the duty cycle of the signal at an input terminal PWMIN, and the decoded value is converted into the reference RPM Ref with the lookup table 22. Alternatively, the value of a configuration register may be used to set the reference RPM. A programming interface 36 is provided for updating the lookup table 22 for the reference RPM assign circuit 19. An operational circuit 26 calculates with the reference RPM Ref and the current feedback RPM FB to generate the error value Err, a compensator 28 having a gain A generates the adjust value Sc according to the error value Err, and a digital pulse width modulator (DPWM) 30 generates the output value OV according to the adjust value Sc for the driver 32 to control the four switches M1, M2, M3 and M4 in the H bridge.

Assuming that the reference RPM Ref is changed from 3000 RPM to 4000 RPM, the RPM of the fan motor 34 will vary correspondingly. As shown in FIG. 3, the RPM of the fan motor 34 starts to change at about 7.5 seconds, and becomes stable at the set value 4000 RPM at about 12.3 seconds. FIG. 4 shows the relationship between the varying RPM and time under different gains, in which waveforms 40, 42 and 44 represent the curves of the output RPM versus time when the gain of the compensator 28 is A1, A2 and A3, respectively, where A3>A1>A2. As shown by the waveforms 40, 42 and 44, under all the gains, the RPM of the fan motor 34 starts to change at about 7.5 seconds, while the compensator 28 having the gain A1 makes the fan motor 34 reaches 4000 RPM at about 12.3 seconds, namely the settling time of 4.8 seconds; the compensator 28 having the gain A2 makes the fan motor 34 reaches 4000 RPM at about 13.8 seconds, namely the settling time of 5.5 seconds; and the compensator 28 having the gain A3 makes the fan motor 34 reaches 4000 RPM at about 12 second, namely the settling time of 4.5 seconds. As shown in FIG. 4, the higher the gain is, the shorter the settling time is, yet the gain excessively high can make the RPM of the fan unstable, as shown in FIG. 5.

### SUMMARY OF THE INVENTION

An objective of the present invention is to provide a controller and control method for a control plant to have a shorter settling time.

Another objective of the present invention is to provide a controller and control method for a control plant to have a stable output value.

A further objective of the present invention is to provide a dynamic gain controller and control method.

According to the present invention, a dynamic gain controller for generating an adjust value for a control plant to control an output value of the control plant, includes a gain selector detecting an error value between an input reference value and a feedback value related to the output value to dynamically select different gains. When the error value is larger than a threshold, the gain is selected to be larger for a shorter settling time, and when the error value is smaller than the threshold, the gain is selected to be smaller to maintain the output value stable.

According to the present invention, a control method for a control plant to control an output value of the control plant includes monitoring the output value to generate a feedback value related to the output value, and selecting different gains according to an error value between the feedback value and a reference value. When the error value is larger than a threshold, the gain is selected to be larger for a shorter settling time, and when the error value is smaller than the threshold, the gain is selected to be smaller to maintain the output value stable.

### BRIEF DESCRIPTION OF THE DRAWINGS

These and other objectives, features and advantages of the present invention will become apparent to those skilled in the art upon consideration of the following description of the preferred embodiments of the present invention taken in conjunction with the accompanying drawings, in which:

FIG. 1 shows a traditional fixed gain close loop linear feedback control system;

FIG. 2 is a functional block diagram of a single phase digital BLDC fan control system;

FIG. 3 is a diagram showing the relationship of the varying RPM of a fan motor versus time;

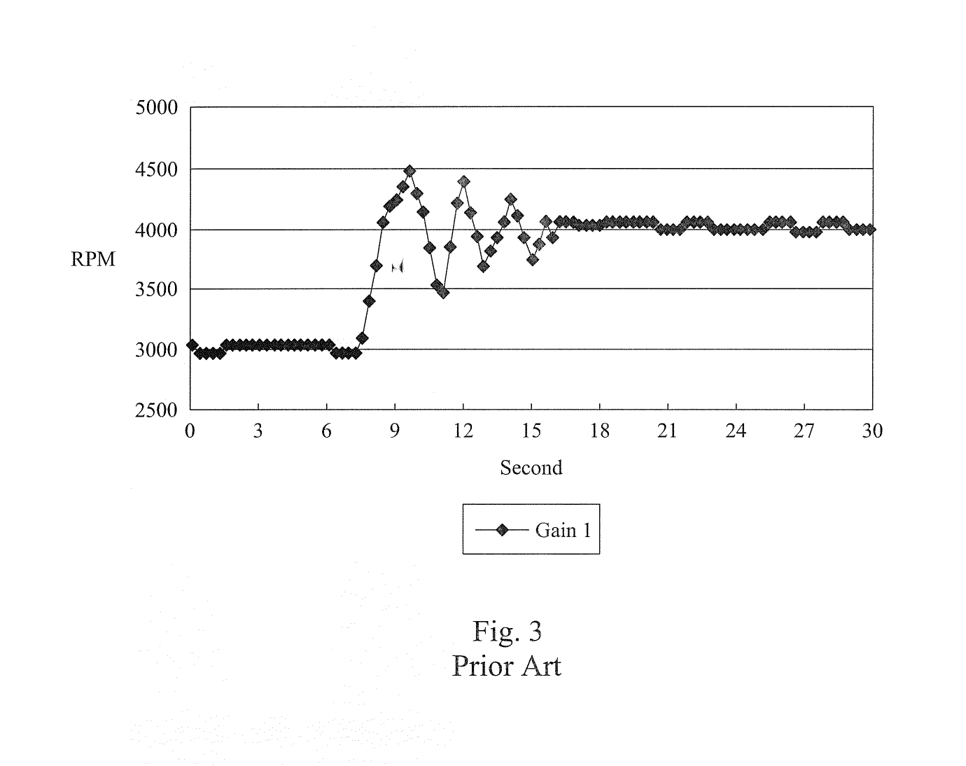

FIG. 4 is a diagram showing the relationship between the varying RPM of a fan motor and time under different gains;

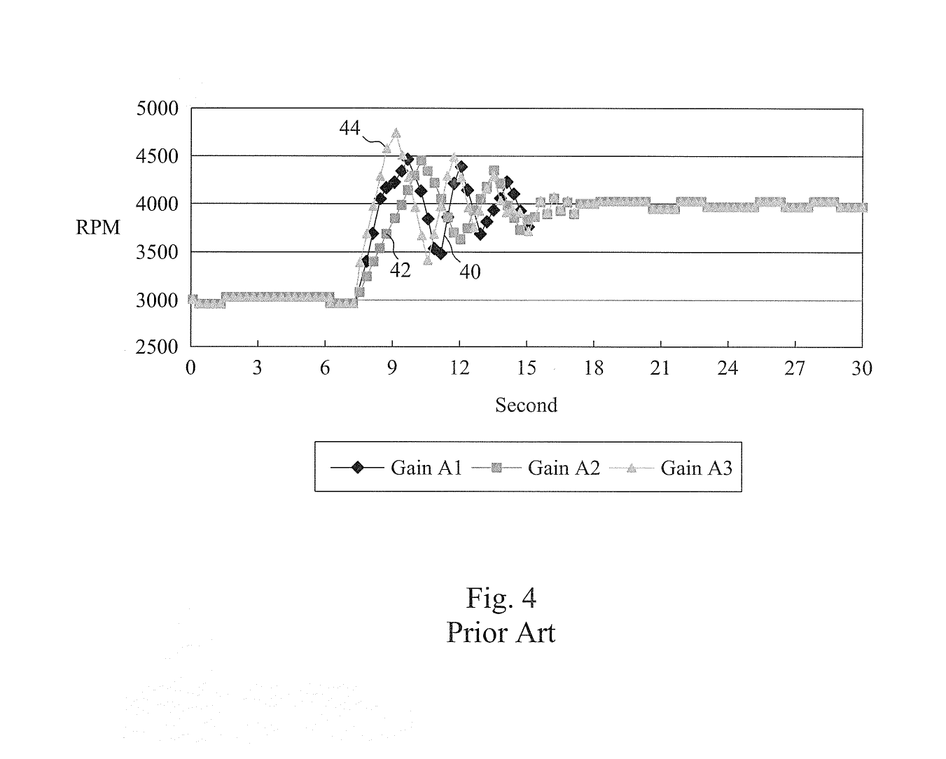

FIG. 5 is a diagram showing the relationship between the varying RPM of a fan motor and time when the gain is excessively large;

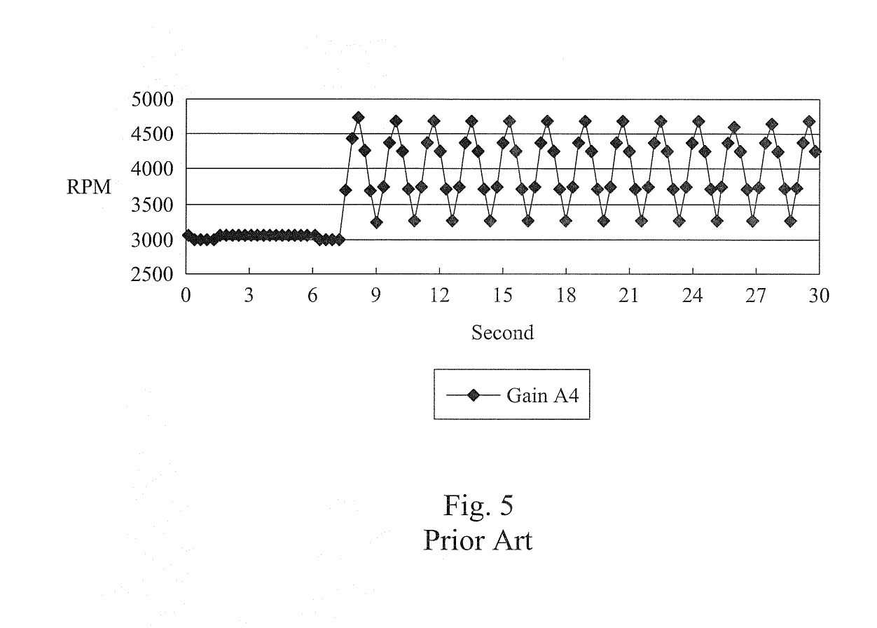

FIG. 6 is a system including a dynamic gain controller according to the present invention;

FIG. 7 is a circuit diagram of an embodiment for the gain selector shown in FIG. 6;

FIG. 8 show experimental data of the control system shown in FIG. 6;

FIG. 9 show experimental data of the control system shown in FIG. 6; and

FIG. 10 is a single phase digital BLDC motor control system using a dynamic gain controller according to the present invention.

### DETAILED DESCRIPTION OF THE INVENTION

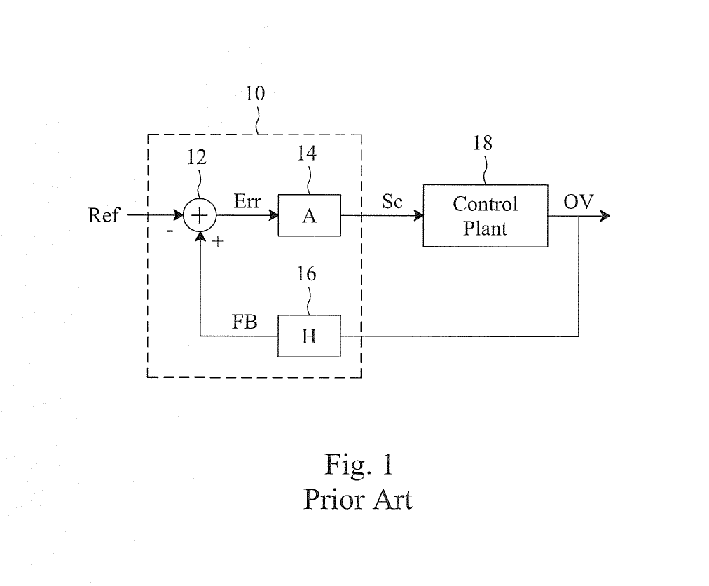

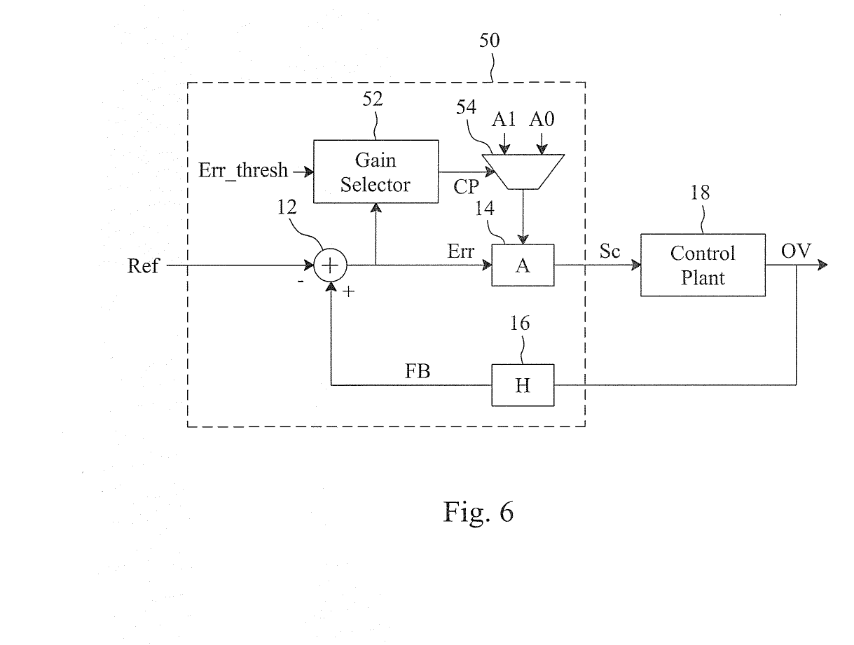

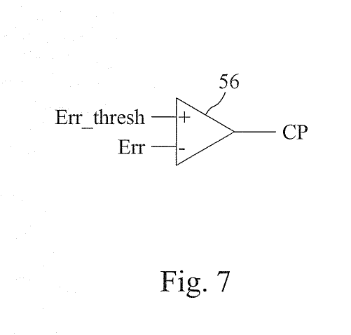

FIG. 6 is a system which includes a dynamic gain controller 50 according to the present invention to provide an adjust value Sc for a control plant 18 to control the output value OV of the control plant 18. In addition to the operational circuit 12, the amplifier 14 and the feedback circuit 16 as shown in FIG. 1, the dynamic gain controller 50 shown in FIG. 6 further includes a gain selector 52 and a multiplexer 54. The gain selector 52 monitors the error value Err generated by the operational circuit 12 and generates a select signal CP according to the error value Err and a preset threshold Err_thresh, and the multiplexer 54 selects one of gains A0 and A1 according to the select signal CP for the amplifier 14 as a control parameter. FIG. 7 is a circuit diagram of an embodiment for the gain selector 52 shown in FIG. 6, which has a comparator 56 for comparing the error value Err with the threshold Err_thresh to generate the select signal CR When the error value Err is larger than the threshold Err_thresh, the select signal CP is low, and the multiplexer 54 selects the larger gain A0 for the amplifier 14 to have a shorter settling time. When the error value Err is smaller than the threshold Err_thresh, the select signal CP is high, and the multiplexer 54 selects the smaller gain A1 for the amplifier 14 to ensure a stable output value OV. The control system shown in FIG. 6 may be either a digital system or an analog system.

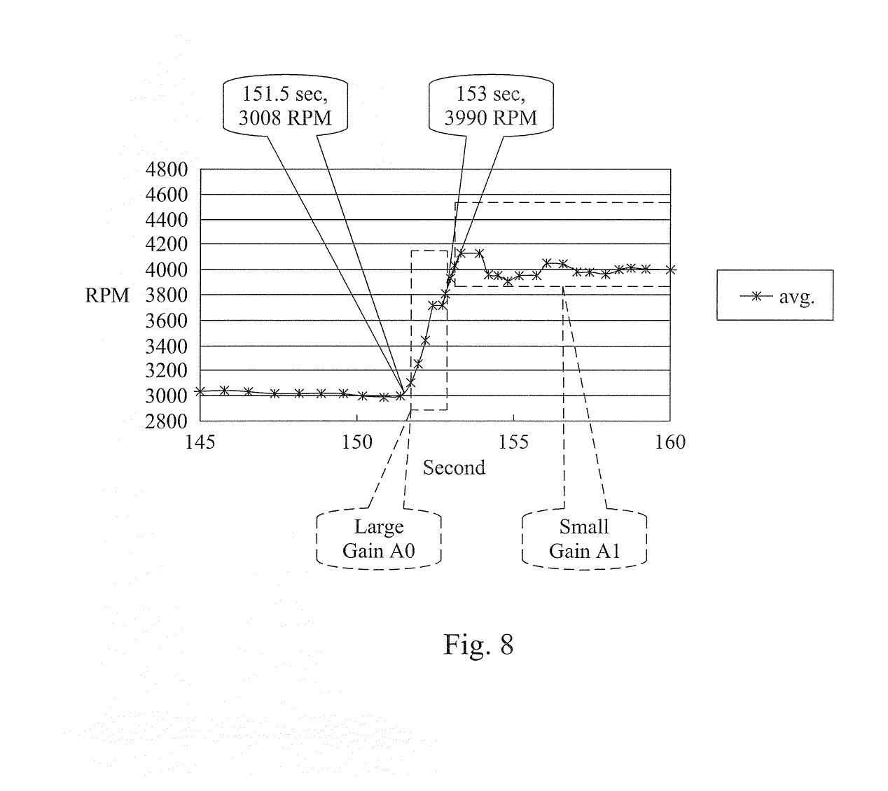

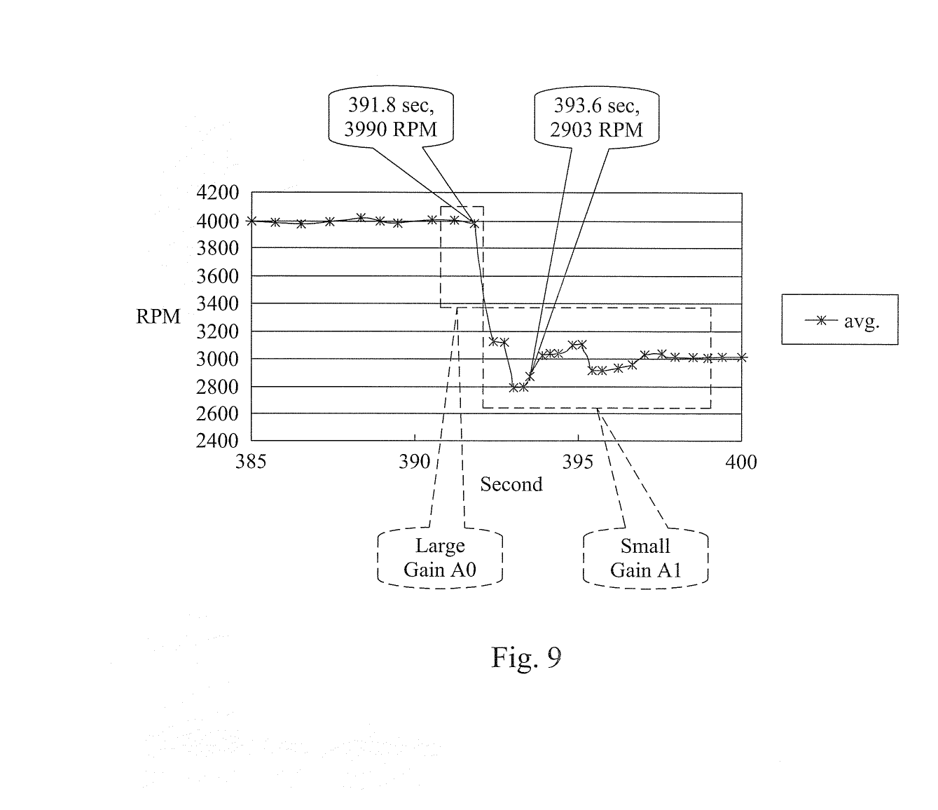

FIGS. 8 and 9 show experimental data of the control system shown in FIG. 6. As shown in FIG. 8, at 151.5 seconds, the reference value Ref of the control system changes from 3000 RPM to 4000 RPM, causing the RPM of the output value OV beginning increasing. At this time, since the error value Err between the feedback value FB and the reference value Ref is larger than the threshold Err_thresh, the larger gain A0 is selected for the amplifier 14. Once the error value Err becomes smaller than the threshold Err_thresh, the smaller gain A1 is selected for the amplifier 14. At last, the RPM of the output value OV stays stably at 4000 RPM at 153 seconds. As shown in FIG. 9, at 391.8 seconds, the reference value Ref of the control system is changed from 4000 RPM to 3000 RPM, causing the RPM of the output value OV beginning decreasing. At this time, since the error value Err between the feedback value FB and the reference value Ref is larger than the threshold Err_thresh, the larger gain A0 is selected for the amplifier 14. Once the error value Err becomes smaller than the threshold Err_thresh, the smaller gain A1 is selected for the amplifier 14. At last, the RPM of the output value OV stays stably at 3000 RPM at 393.6 seconds. As shown in FIGS. 8 and 9, a system using a dynamic gain controller according to the present invention will have a settling time less than two seconds and ensures the output value OV stable.

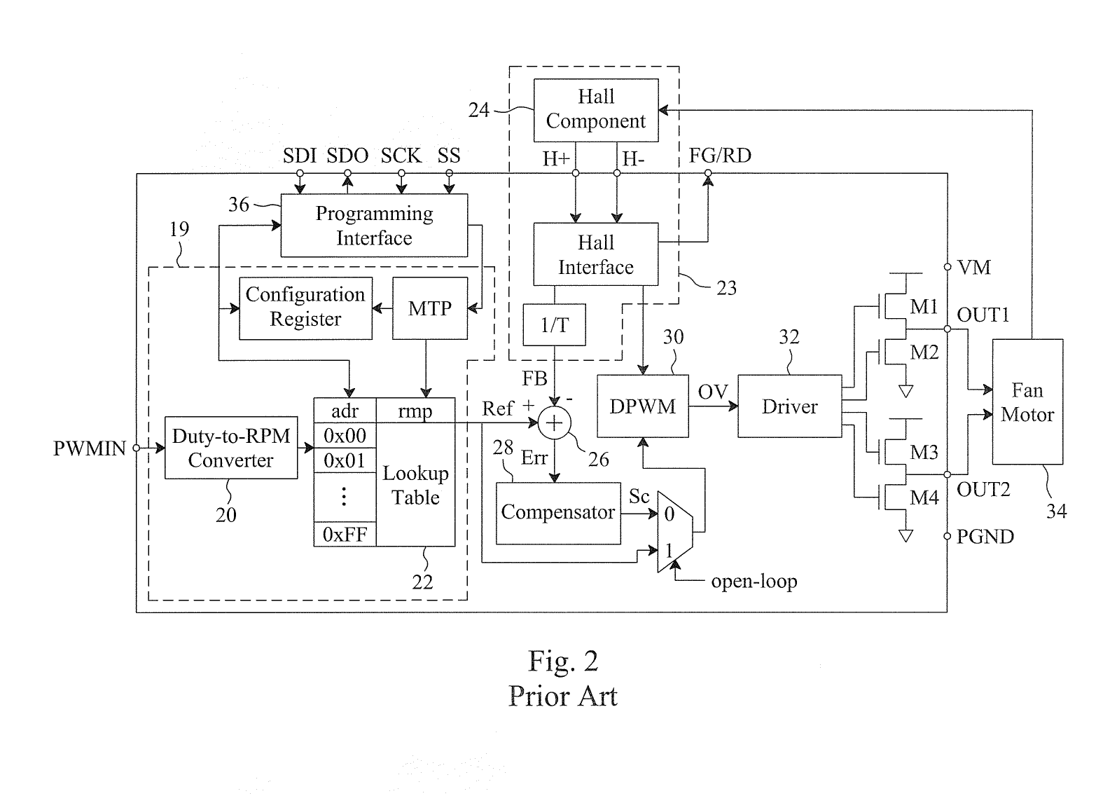

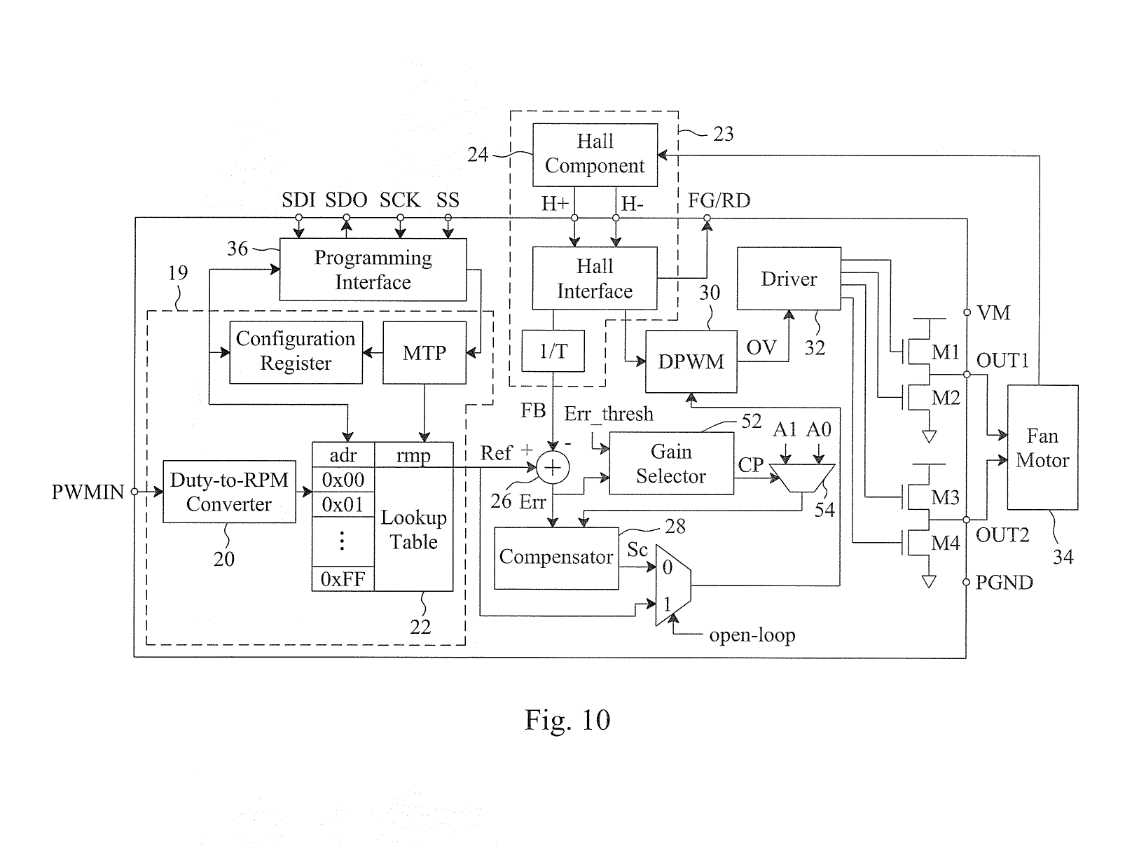

FIG. 10 is a single phase digital BLDC motor control system using a dynamic gain controller according to the present invention. In addition to the circuit shown in FIG. 2, this system further includes a gain selector 52 and a multiplexer 54. The reference RPM generated by the reference RPM assign circuit 19 in FIG. 10 is equal to the reference value Ref in FIG. 6. In FIG. 10, the gain selector 52 has two input terminals to receive a preset threshold Err_thresh and the error value Err generated by the operational circuit 26, and generates a select signal CP accordingly, and the multiplexer 54 selects a gain A0 or A1 for the compensator 28 according to the select signal CP. When the error value Err is larger than the threshold Err_thresh, the multiplexer 54 selects the larger gain A0 for the compensator 28 for a shorter settling time. When the error value Err is smaller than the threshold Err_thresh, the multiplexer 54 selects the smaller gain A1 for the compensator 28 to ensure the output value OV stable.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A dynamic gain controller for generating an adjust value for a control plant to control an output value of the control plant, the dynamic gain controller comprising:
a feedback circuit monitoring the output value to generate a feedback value related to the output value;
an operational circuit connected to the feedback circuit, receiving a reference value, and extracting an error value between the feedback value and the reference value;
an amplifier connected to the operational circuit, amplifying the error value with an adjustable gain to generate the adjust value;
a gain selector connected to the operational circuit, receiving a threshold, and generating a select signal according to the error value and the threshold; and
a multiplexer connected to the gain selector and the amplifier, determining the adjustable gain according to the select signal.

2. The dynamic gain controller of claim 1, wherein the gain selector comprises a comparator comparing the error value with the threshold to generate the select signal.

3. The dynamic gain controller of claim 1, further comprising a reference RPM assign circuit providing the reference value.

4. The dynamic gain controller of claim 3, wherein the reference RPM assign circuit comprises:
a duty-to-RPM converter decoding a duty cycle of an input signal; and
a lookup table providing the reference value according to the decoded result of the duty-to-RPM converter.

5. The dynamic gain controller of claim 4, further comprising a programming interface for updating the lookup table.

6. A control method for a control plant to control an output value of the control plant, the control method comprising the steps of:
monitoring the output value to generate a feedback value related to the output value;
extracting an error value between the feedback value and the reference value;
selecting a gain according to the error value and a threshold;
amplifying the error value with the gain to generate the adjust value; and
controlling the output value according to the adjust value.

7. The control method of claim 6, wherein the step of selecting a gain according to the error value and a threshold comprises step of selecting the gain according to a comparison of the error value with the threshold.

8. The control method of claim 6, further comprising the steps of:
decoding a duty cycle of an input signal; and
determining the reference value according to the decoded result and a lookup table.

9. The control method of claim 8, further comprising the step of updating the lookup table.
